(19) United States
(12) Patent Application Publication
(10) Pub. No.: US 2009/0059146 A1
(43) Pub. Date: Mar. 5, 2009

(54) LIQUID-CRYSTAL DISPLAY DEVICE AND PROCESS OF FABRICATING IT

(75) Inventor: Yasuhiro MORII, (US)

Correspondence Address: MCDERMOTT WILL & EMERY LLP, 600 13TH STREET, N.W., WASHINGTON, DC, 20005-3096, US

(73) Assignee: MITSUBISHI ELECTRIC CORPORATION, Tokyo (JP)

(21) Appl. No.: 12/263,899

(22) Filed: Nov. 3, 2008

Related U.S. Application Data
(63) Continuation of application No. 11/524,212, filed on Sep. 21, 2006.
Application No. 11/524,212 is a division of application No. 09/588,478, filed on Jun. 7, 2000, now abandoned.

(51) Int. Cl. G02F 1/1337

(52) U.S. Cl. 349/123

(57) ABSTRACT

Provided is an in-plane response-type liquid-crystal display device having a sufficiently high contrast ratio enough to display high-quality images. The device is free from the problem of light leak to be caused by spacers, and is free from the problem of rough surface appearances. In the device, the surface of each spacer is coated with a thermoplastic polymer prepared through graft polymerization of a molecular compound having a vinyl group or a polymerization initiator, with one or more polymerizable monomers. The functional groups existing in the surface of each spacer are bonded to the alignment layers adjacent to the spacers via van der Waals bonding or hydrogen bonding, whereby the spacers are fixed onto the orientation film on at least one of the electrode substrate and the color filter substrate constituting the device. The bonds are extremely small, and the region around the spacers through which light will leak is much reduced. In addition, the spacers are prevented from moving to scratch the neighboring alignment layers, and light leak through the device is prevented. The spacers preferably have a number of long-chain alkyl groups each having at least 6 carbon atoms in their surfaces, and light leak around the spacers is well prevented.

### RELATED APPLICATIONS

This application is a Continuation of U.S. application Ser. No. 11/524,212, filed Sep. 21, 2006, which is a Divisional of U.S. application Ser. No. 09/588,478, filed Jun. 7, 2000, now abandoned, the entire contents of each of which are hereby incorporated by reference.

### BACKGROUND OF THE INVENTION

1. Field of the Invention

The present invention relates to an in-plane response-type liquid-crystal display device, in particular, to a specific material of the spacers for defining the panel space in the device and to a specific structure of the device which, in black display condition, is free from the problem of light leak to be caused by spacer disposition therein.

2. Description of the Related Art

As being thin and lightweight and having the advantage of low power consumption, liquid-crystal display devices are widely used as image-displaying units in wristwatches, pocket calculators, etc. In particular, TN-type liquid-crystal display devices with an active system to be driven by thin-film transistors (TFTs) and the like are being used as image displaying units in the field of word processors, personal computers and others in which CRTs have heretofore been used.

In general, however, the angle of visibility on such TN-type liquid-crystal display devices is narrow. Therefore, viewers who see the devices obliquely often meet with the troubles of image contrast reduction and reversed image expression. To solve the problem, in-plane response-type liquid-crystal display devices have been proposed. The driving principle of one typical in-plane response-type liquid-crystal display device is described with reference to FIGS. 8A and 8B.

FIGS. 8A and 8B are schematic views showing the structure of an ordinary in-plane response-type liquid-crystal display device. In these, 1a and 1b are comb-structured electrodes both formed on one and the same substrate; 2 is a liquid-crystal molecule; 3 is an electrode substrate on which are formed plural comb-structured electrodes 1a and 1b; 4 is a counter substrate; 5 is an equipotential line of the electric field applied between the comb-structured electrodes 1a and 1b; 6 is incident light; 7 and 8 are polarizing plates each having a transmission axis in the direction of the arrow illustrated; 9 is the light having passed through the device; and 10 indicates the orientation direction of the liquid crystal molecules. FIG. 8A shows the liquid crystal orientation in the device with no voltage being applied between the pair of comb-structured electrodes 1a and 1b; and FIG. 8B shows the liquid crystal orientation in the device with a voltage being applied between the pair of comb-structured electrodes 1a and 1b.

With no voltage being applied to the device, the liquid crystal molecules 2 are oriented in the direction 10, as in FIG. 8A. In this condition, when the polarizing plates 7 and 8 are so disposed that the transmission axis of the plate 7 is to be parallel to the orientation direction 10 while that of the plate 8 is to be perpendicular thereto, then the incident light 6 could not pass through the polarizing plate 8. In this, therefore, the device shall be in a black (dark) condition. On the other hand, when a voltage is applied between the comb-structured electrodes 1a and 1b, then an electric field is formed, running in the direction nearly parallel to the surface of the substrate, whereby the orientation direction of the liquid-crystal molecules 2 is varied. In other words, the birefringence of the liquid-crystal layer is varied. In that condition, the incident light 6 passes through the polarizing plate 8, and the device shall be in a white (light) condition. Specifically, in the in-plane response-type liquid-crystal display device with no voltage being applied thereto, the liquid-crystal layer has no influence on the linear, polarized incident light 6 having passed through one polarizing plate 7, of which the absorption axis or transmission axis is parallel to the orientation direction 10 of the liquid-crystal molecules 2, and the polarized light 6 directly reaches the other polarizing plate 8 of which the transmission axis or absorption axis is perpendicular to that of the polarizing plate 7. In that condition, the light 6 could not pass through the polarizing plate 8, and the device is in a black (dark) condition.

In that manner, the in-plane response-type liquid-crystal display device, the response to voltage of the liquid-crystal molecules 2 is nearly parallel to the surface of the substrate, depending on the presence or absence of the voltage applied to the device. Accordingly, the change in the viewing direction to the device is influenced little by the optical behavior of the liquid-crystal molecules 2 in the device, and the device is almost free from image contrast reduction and image quality degradation irrespective of the viewing angle variation, and could all the time have extremely excellent viewing angle-independent visibility characteristics.

However, in actual in-plane response-type liquid-crystal display devices, the liquid crystal orientation is often in mono-axial confusion around the spacers which are to define the panel space, as in FIGS. 9A and 9B. In that condition, the incident light passing through the liquid-crystal layer undergoes birefringence to give oval polarized rays, and the thus-polarized oval rays can pass through the other polarizing plate. This is the problem of light leak in the black (dark) condition of the devices. In FIGS. 9A and 9B, 11 and 13 indicate the area where the liquid crystal orientation is in confusion; 12 is a spacer; 14 is an alignment layer formed on the counter substrate 4; 15 is an alignment layer formed on the electrode substrate 3. In these, the same members are represented by the same reference numbers as in FIGS. 8A and 8B, and their description is omitted herein.

The liquid crystal orientation confusion will be in the morphology of FIG. 9A or FIG. 9B or in a mixed morphology of the two, depending on the combination of the material of the spacer 12 and the material of the liquid-crystal molecules 2. In addition, further depending on the surface condition of the spacer 12, the liquid crystal orientation confusion shall still vary, and the liquid crystal orientation varies irregularly and not regularly. With the liquid crystal orientation being thus in confusion, the incident light having entered the liquid-crystal layer from the lower side of the panel shall undergo birefringence in the layer, and passes through the layer and though the upper side of the panel. This is light leak through the device. The light leak is especially noticeable in black expression, and much detracts from the image contrast ratio which is one important characteristic feature of liquid-crystal display devices. The image contrast ratio is represented by (luminance (transmittance) in white (light) condition)/(luminance (transmittance) in black (dark) condition). With the light leak, the luminance (transmittance) in the black condition increases, whereby the image contrast ratio decreases. When seen, the panel with the problem of light leak gives rough surface appearance. This is another problem caused by light leak through display devices.

On the other hand, if the surfaces of the alignment layers 14 and 15 are scratched with the spacer 12, the liquid crystal molecules will be oriented not in order and will form an irregularly oriented area, through which light will leak in a black (dark) condition. The light leak in that condition is described with reference to FIGS. 10A and 10B. In these figures, 14a and 15a are the alignment layers around the spacer 12; and 16 and 17 indicate the areas in which the liquid crystal orientation is in confusion. In general, the spacer 12 is made of a single substance of silica, divinylbenzene, acrylate resin or the like, and this is physically or chemically restrained by the alignment layer 14 or the alignment layer 15 inside the panel. Accordingly, when physical vibration or load is applied to the panel, the spacer 12 will move or will be pressed against the upper and lower substrates. As a result, one or both of the alignment layers 14a and 15a around the spacers will be damaged or scratched, whereby the liquid crystal orientation in the areas 16 and 17 will be disordered. Through the areas 16 and 17 in which the liquid crystal orientation is in confusion, light leaks in a black (dark) condition, thereby causing the problems of image contrast reduction and rough surface appearance.

To solve the problems as above, spacers are dispersed or fixed in conventional liquid-crystal display devices, for example, as in Japanese Patent Laid-Open Nos. 136916/1992, 60517/1992, and 160051/1997. In these, plural spacers are selectively disposed at predetermined sites on a substrate. On the other hand, liquid-crystal display devices with spacers fixed on a substrate and a process of fabricating the devices are proposed in Japanese Patent Laid-Open Nos. 120719/1990 and 160433/1996. In these, the surface of each spacer is coated with an adhesive resin such as a thermoplastic resin or the like, and the thus-coated spacers are fixed on a substrate via the adhesive resin therebetween. However, for selectively disposing plural spacers at predetermined sites on a substrate, the production steps and the material must be increased, causing the increase in the production costs. In the other technique of coating spacers with an adhesive material, the adhesive material will dissolve out and the area for the spacers shall increase. Accordingly, the technique is problematic in that the area of light leak will increase, that the liquid-crystal material will be contaminated with the adhesive material and the thermoplastic resin used, and that additional plants and steps will be necessary for reacting the adhesive material and the thermoplastic resin.

### SUMMARY OF THE INVENTION

The present invention has been made to solve the problems as above, and its object is to provide an in-plane response-type liquid-crystal display device capable of displaying high-quality images, in which light leak to be caused by the spacers is prevented, which ensures a sufficiently high image contrast ratio, and of which the panel surface has no rough appearance. Another object of the invention is to provide a process of fabricating the liquid-crystal display device, for which the production costs are not increased.

Specifically, one embodiment of the liquid-crystal display device of the invention comprises a first substrate having thereon plural electrodes that include a scanning signal line, an image signal line, a pixel electrode and others; a second substrate having thereon a color filter, a light-shielding film and others, and spaced from the first substrate via a predetermined distance therebetween; an alignment layer formed on each of the facing surfaces of the two substrates; spacers to define the distance between the two substrates; and a liquid crystal layer disposed between the two substrates. To the device, a voltage is applied between the electrodes to thereby form an electric field nearly parallel to the surfaces of the substrates so that the liquid crystal molecules therein undergo in-plane response to the electric field. The device is characterized in that the surface of each spacer is coated with a thermoplastic polymer prepared through graft polymerization of a molecular compound having a vinyl group or a polymerization initiator, with one or more polymerizable monomers at the grafting point of the vinyl group or the polymerization initiator; and each spacer is fixed onto the alignment layer on at least one of the first substrate and the second substrate, via van der Waals bonding or hydrogen bonding between the functional group of the monomers constituting the thermoplastic polymer and the alignment layer.

In the device, preferably, the thermoplastic polymer has a number of long-chain alkyl groups in its surface.

Another embodiment of the liquid-crystal display device of the invention comprises a first substrate having thereon plural electrodes that include a scanning signal line, an image signal line, a pixel electrode and others; a second substrate having thereon a color filter, a light-shielding film and others, and spaced from the first substrate via a predetermined distance therebetween; an alignment layer formed on each of the facing surfaces of the two substrates; spacers to define the distance between the two substrates; and a liquid crystal layer disposed between the two substrates, to which is applied a voltage between the electrodes to thereby form an electric field nearly parallel to the surfaces of the substrates so that the liquid crystal molecules in the device undergo in-plane response to the electric field, and in which the spacers are made of a polymer compound having a number of long-chain alkyl groups in its surface.

Preferably, in the polymer compound for the spacers, the long-chain alkyl groups are bonded to the graft polymer chains through graft polymerization.

Also preferably, the long-chain alkyl groups each have at least 6 carbon atoms.

Still another embodiment of the liquid-crystal display device of the invention comprises a first substrate having thereon plural electrodes that include a scanning signal line, an image signal line, a pixel electrode and others; a second substrate having thereon a color filter, a light-shielding film and others, and spaced from the first substrate via a predetermined distance therebetween; an alignment layer formed on each of the facing surfaces of the two substrates; spacers to define the distance between the two substrates; and a liquid crystal layer disposed between the two substrates, to which is applied a voltage between the electrodes to thereby form an electric field nearly parallel to the surfaces of the substrates so that the liquid crystal molecules in the device undergo in-plane response to the electric field, and in which a projecting pattern is locally formed below the alignment layer on the first substrate but above one or both of the scanning signal line and the image signal line, and the distance between the first substrate and the second substrate is defined by the spacers disposed on the projecting pattern while the spacers in the other region are so controlled that they are not kept in contact with any one of the first substrate and the second substrate.

Still another embodiment of the liquid-crystal display device of the invention comprises a first substrate having thereon plural electrodes that include a scanning signal line, an image signal line, a pixel electrode and others; a second substrate having thereon a color filter, a light-shielding film and others, and spaced from the first substrate via a predetermined distance therebetween; an alignment layer formed on each of the facing surfaces of the two substrates; spacers to define the distance between the two substrates; and a liquid crystal layer disposed between the two substrates, to which is applied a voltage between the electrodes to thereby form an: electric field nearly parallel to the surfaces of the substrates so that the liquid crystal molecules in the device undergo in-plane response to the electric field, and in which a projecting pattern is locally formed below the alignment layer on the second substrate but above the light-shielding film, and the distance between the first substrate and the second substrate is defined by the spacers disposed on the projecting pattern while the spacers in the other region are so controlled that they are not kept in contact with any one of the first substrate and the second substrate.

Preferably, the projecting pattern has a height of at least 0.6 μm.

Still another embodiment of the liquid-crystal display device of the invention comprises a first substrate having thereon plural electrodes that include a scanning signal line, an image signal line, a pixel electrode and others; a second substrate having thereon a color filter, a light-shielding film and others, and spaced from the first substrate via a predetermined distance therebetween; an alignment layer formed on each of the facing surfaces of the two substrates; spacers to define the distance between the two substrates; and a liquid crystal layer disposed between the two substrates, to which is applied a voltage between the electrodes to thereby form an electric field nearly parallel to the surfaces of the substrates so that the liquid crystal molecules in the device undergo in-plane response to the electric field, and in which projecting patterns are locally formed below the alignment layer on the first substrate but above one or both of the scanning signal line and the image signal line, and below the alignment layer on the second substrate but above the light-shielding film in such a manner that the two patterns face to each other, and the distance between the first substrate and the second substrate is defined by the spacers disposed between the facing projecting patterns while the spacers in the other region are so controlled that they are not kept in contact with any one of the first substrate and the second substrate.

Preferably, the total height of the projecting patterns formed on the first substrate and the second substrate is at least 0.6 μm.

Also preferably, the projecting patterns are made of pigment or an insulating material such as SiN, SiO₂ or the like.

Still another embodiment of the liquid-crystal display device of the invention comprises a first substrate having thereon plural electrodes that include a scanning signal line, an image signal line, a pixel electrode and others; a second substrate having thereon a color filter, a light-shielding film and others, and spaced from the first substrate via a predetermined distance therebetween; an alignment layer formed on each of the facing surfaces of the two substrates; spacers, to define the distance between the two substrates; and a liquid crystal layer disposed between the two substrates, to which is applied a voltage between the electrodes to thereby form an electric field nearly parallel to the surfaces of the substrates so that the liquid crystal molecules in the device undergo in-plane response to the electric field, and in which the diameter of each spacer is smaller in some degree than the distance between the two substrates so that the spacers are not kept in contact with any one of the first, substrate and the second substrate.

Preferably, the diameter, d, of each spacer satisfies D−d>0.2 μm in which D indicates the distance between the two substrates.

Still another embodiment of the liquid-crystal display device of the invention comprises a first substrate having thereon plural electrodes that include a scanning signal line, an image signal line, a pixel electrode and others; a second substrate having thereon a color filter, a light-shielding film and others, and spaced from the first substrate via a predetermined distance therebetween; an alignment layer formed on each of the facing surfaces of the two substrates; spacers to define the distance between the two substrates; and a liquid crystal layer disposed between the two substrates, to which is applied a voltage between the electrodes to thereby form an electric field nearly parallel to the surfaces of the substrates so that the liquid crystal molecules in the device undergo in-plane response to the electric field, and in which the inner pressure in the area where liquid crystal molecules are disposed is lower by at most 0.3 kgf/cm² than the atmospheric pressure.

One embodiment of the process of fabricating a liquid-crystal display device of the invention comprises a step of forming a panel by sealing a first substrate having plural electrodes that include a scanning signal line, an image signal line, a pixel electrode and others, and an alignment layer all formed thereon, and a second substrate having a color filter, a light-shielding film and an alignment layer all formed thereon, with a sealant formed between the two substrates and around the outer peripheries of the substrates in such a manner that it partly reaches the edges of the substrates to form an opening through which liquid crystal is to be injected into the space between the sealed substrates; and a step of setting the panel in a liquid crystal-injecting unit having therein a container filled with liquid crystal, evacuating both the liquid crystal-injecting unit and the panel, putting the opening of the panel into the liquid crystal in the container, thereafter restoring the liquid crystal-injecting unit to have an atmospheric pressure in that condition so that the liquid crystal is injected into the panel through its opening owing to the inner pressure difference between the unit and the panel, and finally sealing the opening of the panel in such a condition that the panel receives no external pressure.

Another embodiment of the process of fabricating a liquid-crystal display device of the invention comprises a step of forming a panel by sealing a first substrate having plural electrodes that include a scanning signal line, an image signal line, a pixel electrode and others, and an alignment layer all formed thereon, and a second substrate having a color filter, a light-shielding film and an alignment layer all formed thereon, with a sealant formed between the two substrates and around the outer peripheries of the substrates in such a manner that it partly reaches the edges of the substrates to form an opening through which liquid crystal is to be injected into the space between the sealed substrates; and a step of setting the panel in a liquid crystal-injecting unit having therein a container filled with liquid crystal, evacuating both the liquid crystal-injecting unit and the panel, putting the opening of the panel into the liquid crystal in the container, thereafter restoring the liquid crystal-injecting unit to have an atmospheric pressure in that condition so that the liquid crystal is injected into the panel through its opening owing to the inner pressure difference between the unit and the panel, then keeping the panel as it is until its inner pressure increases to be lower by at most 0.3 kgf/cm² than the atmospheric pressure, and finally sealing the opening of the panel.

### BRIEF DESCRIPTION OF THE DRAWINGS

FIGS. 1A through F are flowcharts of Embodiment 1 of the invention, illustrating a process of fabricating an in-plane response-type liquid-crystal display device, and this shows cross-sectional views of the components of the device being fabricated.

FIGS. 2A through 2C are flowcharts of Embodiment 3 of the invention, illustrating a process of fabricating an in-plane response-type liquid-crystal display device, and this shows cross-sectional views of the components of the device being fabricated.

FIG. 3 is a cross-sectional view of the in-plane response-type liquid-crystal display device fabricated in Embodiment 3.

FIGS. 4A through 4C are flowcharts of Embodiment 4 of the invention, illustrating a process of fabricating an in-plane response-type liquid-crystal display device, and this shows cross-sectional views of the components of the device being fabricated.

FIG. 5 is a cross-sectional view of the in-plane response-type liquid-crystal display device fabricated in Embodiment 4.

FIGS. 6A through 6C are to illustrate a process of fabricating an in-plane response-type liquid-crystal display device of Embodiment 6 of the invention.

FIG. 7 shows a relationship between the panel space in a liquid-crystal display device and the relaxation time for the panel.

FIG. 8A and FIG. 8B are schematic views showing the structure of an ordinary, in-plane response-type liquid-crystal display device.

FIG. 9A and FIG. 9B are schematic views indicating the phenomenon of light leak through conventional, in-plane response-type liquid-crystal display devices, in which the light leak around the spacer is caused by the mono-axial liquid crystal orientation confusion around it.

FIG. 10A and FIG. 10B are schematic view indicating the phenomenon of light leak through conventional, in-plane response-type liquid-crystal display devices, in which the alignment layers contacted with the spacer are damaged or scratched by the spacer to induce liquid crystal orientation confusion around the spacer, and the light leak is caused by the liquid crystal orientation confusion.

In these drawings, 1a and 1b are comb-structured electrodes; 2 is a liquid crystal molecule; 3 is an electrode substrate; 4 is a counter electrode; 5 is an equipotential line; 6 is incident light; 7 and 8 are polarizing plates; 9 is the light having passed through the device; 10 is the direction in which liquid crystal molecules are oriented; 11, 13, 16 and 17 are the areas in which the liquid crystal orientation is in confusion; 12 is a spacer; 14 and 15 are alignment layers; 20 is a glass substrate; 21 is a source wire; 22 is a gate-insulating film; 23 is a pixel electrode; 24 is an alignment layer; 25 is a glass substrate; 26 is a light-shielding film; 27 is a color filter; 28 is an overcoat film; 29 is an alignment layer; 30, 30a, and 30b are spacers; 31 is a liquid crystal layer; 32 and 33 are projecting patterns; 34 is a sealant; 35 is an opening; 36 is liquid crystal; 37 is a dish for liquid crystal; 38 is the inner area of a panel; 39 is a liquid crystal-injecting unit; 40 is a roller; 100 and 100a are electrode substrates; 101 and 101a are color filter substrates.

### DESCRIPTION OF THE PREFERRED EMBODIMENTS

### Embodiment 1

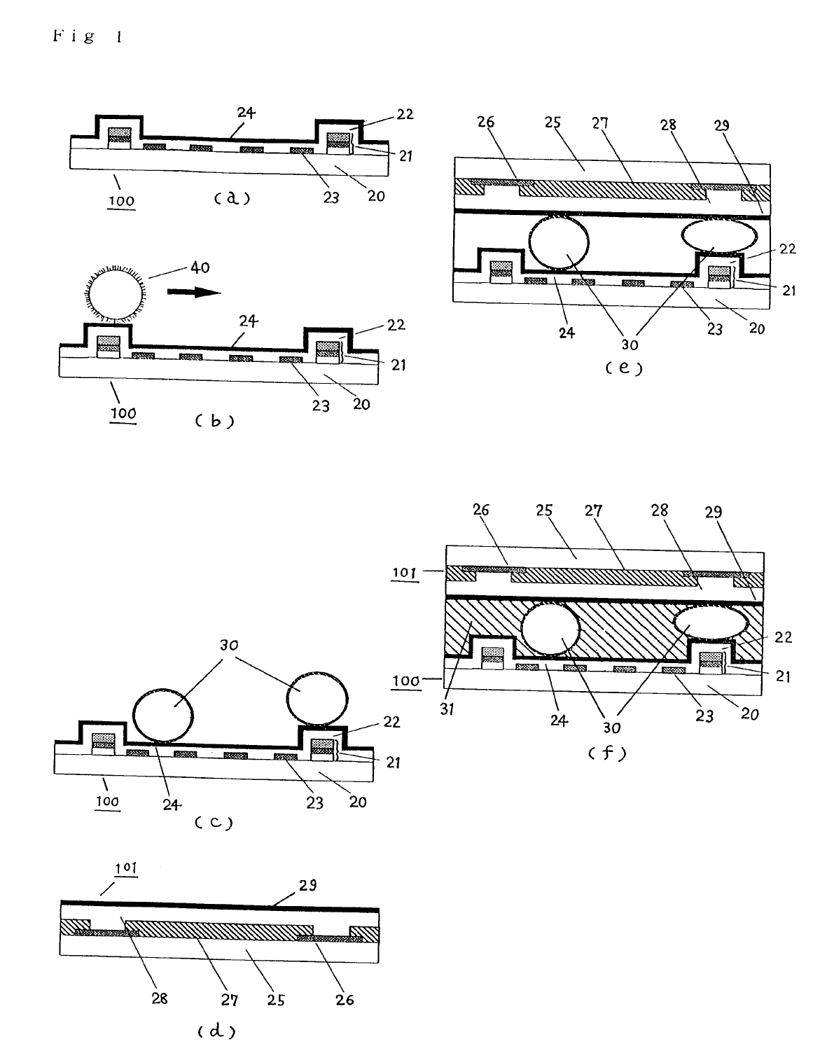

Embodiments of the invention are described with reference to the drawings attached hereto. FIG. 1 is a flowchart of Embodiment 1, illustrating a process of fabricating an in-plane response-type liquid-crystal display device of the invention, and this shows cross-sectional views of the components of the device being fabricated. In FIG. 1, 100 is an electrode substrate (first substrate) having plural electrodes that include a scanning signal line, an image signal line, a pixel electrode and others all formed thereon; 20 is a glass substrate; 21 is a source wire to be an image signal line; 22 is a gate-insulating film; 23 is a pixel electrode; and 24 is an alignment layer. In this, 101 is a color filter substrate (second substrate) having a color filter, a light-shielding film and others formed thereon, and spaced from the electrode substrate 100 via a predetermined distance therebetween; 25 is a glass substrate; 26 is a light-shielding film of pigment or metal such as chromium or the like; 27 is a color filter of pigment of dye; 28 is an overcoat film of an organic or inorganic material, which is for improving the reliability of the color filter; and 29 is an alignment layer. The alignment layers 24 and 29 are formed on the facing surfaces of the two substrates 100 and 101. 30 is a spacer to define the distance between the two substrates 100 and 101; 31 is a liquid crystal layer disposed between the two substrates 100 and 101; and 40 is a roller for rubbing treatment.

In this embodiment, a voltage is applied between the electrodes formed on the electrode substrate 100 to thereby form an electric field nearly parallel to the surface of the substrate so that the liquid crystal molecules in the device undergo in-plane response to the electric field. In the device, the surface of each spacer 30, which is to define the distance between the two substrates, the electrode substrate 100 and the color filter substrate 101, is coated with a thermoplastic polymer. The thermoplastic polymer is prepared through graft polymerization of a molecular compound having a vinyl group or a polymerization initiator, with one or more polymerizable monomers at the grafting point of the vinyl group or the polymerization initiator. Thus coated, each spacer 30 is fixed onto at least one of the electrode substrate 100 and the color filter substrate 101, as the functional group of the monomers constituting the thermoplastic polymer is bonded to the alignment layers 24 and 29 via van der Waals bonding or hydrogen bonding therebetween.

Branched polymers formed through graft polymerization are referred to as graft polymers. These are obtained by making the main chain of a polymer have active groups to be radical sources followed by adding a monomer to each active radical source and thereafter extending the branches. Graft polymers are characterized in that the monomers constituting the stem (main chain part) differ from those constituting the grafts (branches). In this embodiment, the surface of each spacer 30 has functional groups derived from the graft-polymerized monomers, such as hydroxyl groups, carboxyl groups, epoxy groups, silyl groups, silanol groups, isocyanate groups, etc. These functional groups bond to the alignment layers 24 and 29 via van der Waals bonding or hydrogen bonding therebetween, and the bonds are extremely small. Therefore, the region around the spacer 30 through which light will leak is much reduced. In this embodiment, there still remains the problem of light leak through the region around each spacer 30, owing to the mono-axial orientation confusion around it. In this, however, each spacer 30 is fixed to the alignment layers 24 and 29, and therefore it is possible to prevent the spacers from moving to scratch the films 24 and 29. As a result, in this, it is possible to remove the most significant factor of light leak to be caused by scratched alignment layers.

The thermoplastic polymer to coat each spacer 30 may have a number of long-chain alkyl groups in its surface. With each spacer 30 coated with the thermoplastic polymer of that type, light leak through the area around each spacer 30 can be prevented. The long-chain alkyl groups are bonded to the graft polymer chain through graft polymerization, and preferably have at least 6 carbon atoms each. This will be described in detail in Embodiment 2 to be mentioned below.

The process of fabricating a liquid-crystal display device of this embodiment is described. First, as in FIG. 1A, plural electrodes, such as a gate wire to be a scanning signal line, a source wire 21 to be an image signal line, a pixel electrode 23 and others are formed on a glass substrate 20 through photolithography to prepare an electrode substrate 100. The source wire 21 is composed of amorphous silicon of 0.2 μm thick, Cr of 0.1 μm thick and Al of 0.3 μm thick; the gate-insulating film is of SiN having a thickness of 0.4 μm; and the pixel electrode 23 is of Cr having a thickness of 0.1 μm. On the electrode substrate 100, formed is an alignment layer 24 (Nippon Synthetic Rubber's AL1044) having a thickness of 0.07 μm. This is heated in an oven at 180° C. and cured. Next, as in FIG. 1B, the cured, alignment layer 24 is rubbed with a roller 40 coated with a nylon rubbing cloth. Thus is finished the electrode substrate 100 for an in-plane response-type liquid-crystal display derive to which an electric field is applied in the direction parallel to the surface of the substrate. Next, as in FIG. 1C, spacers 30 (Natoco Paint's KSE, spacer diameter: 4.0±0.2 μm) each having functional

groups such as those mentioned above on the surface are dispersed on the substrate. The density of the spacers 30 is 300/cm² on average, varying within the range of from 200 to 400/cm².

Next, as in FIG. 1D, a light-shielding film 26 of pigment or metal such as chromium or the like, a color filter 27 of pigment or dye, and an overcoat film 28 of an organic or inorganic material are formed on a different glass substrate 25 through photography. On this is formed an alignment layer (Nippon Synthetic Rubber's AL1044) having a thickness of 0.07 μm. The film is heated in an oven at 180° C., and cured, and thereafter rubbed. Thus is finished a color filter substrate 101. A sealant (not shown) of an epoxy adhesive, which is to seal the two substrates, is applied to the peripheral area around the alignment layer 29 formed on the color filter substrate 101. To apply the sealant thereto, used is a dispenser.

Next, as in FIG. 1E, the two substrates are combined in such a manner that the pixel electrode region on the electrode substrate 100 faces the color filter 27 on the color filter substrate 101. Then, a pressure of 0.5 kgf/cm² is applied to the thus-combined substrates while heating them at 150° C., whereby the sealant is cured and the two substrates are thus sealed through thermal pressurization. In this step, the sealant is cured and the distance between the facing two substrates is unified via the spacers 30 therebetween. The spacers 30 are thus fixed to the alignment layers 24 and 29, as the functional groups existing in the surface of each spacer 30 are bonded to the films.

Next, as in FIG. 1F, liquid crystal 31 is injected into the space between the substrates under reduced pressure. There is known a technique of pressing the two substrates between which liquid crystal has been injected under reduced pressure, to thereby remove the excess liquid crystal, and thereafter sealing the two substrates. However, the pressure to be applied to the substrates in this technique for removing the excess liquid crystal is large. Such high pressure, if applied to the case of the invention, will break the bonds between the spacers 30 and the alignment layer 24 or 29. Therefore, the pressure method should not apply to the embodiment of the invention. We have confirmed that the bonds between the spacers 30 and the alignment layer 24 or 29 are broken to a degree of 50% or more in the pressure method. Accordingly, in the reduced pressure method employed in the embodiment of the invention for liquid crystal injection, the two substrates are left as such for 1 hour after the liquid crystal 31 injected into the space between the substrates has reached the end of the space opposite to the inlet opening, and thereafter the two substrates are sealed with no pressure applied thereto.

In the in-plane response-type liquid-crystal display device thus fabricated according to the process mentioned above, the spacers 30 each having functional groups on their surface are bonded to the alignment layers 24 and 29. Therefore, even though some physical shock is applied to the panel, the spacers 30 do not move. In addition, since the area at which the spacers are bonded to the films is extremely small, light leak through it is much reduced. Accordingly, the device is free from the problems of contrast ratio depression and rough surface appearance, and all the time enjoys good display characteristics.

Depending on the surface profile of the electrode substrate 100 and the color filter substrate 101, the size of the spacers 30, and the pressure to be applied to the substrates for sealing them, and also on the combination of such parameters in fabricating the device, the spacers 30 may be fixed onto only either one of the electrode substrate 100 or the color filter substrate 101 in the thermal pressurization step. Even in that case, the spacers 30 are surely prevented from moving, and the device can naturally enjoy the intended effect of the invention.

### Embodiment 2

In the section of this embodiment, described is the spacer material capable of preventing light leak to be caused by the mono-axial orientation confusion seen around conventional spacers. The structure of the in-plane response-type liquid-crystal display device of this embodiment is the same as the structure (FIG. 1) of the device of Embodiment 1 mentioned above, except for the spacer material used. Therefore, illustrating the structure of the device of this embodiment by means of drawings is omitted.

The spacers for use in this embodiment are made of a polymer compound having a number of long-chain alkyl groups in the surface. The long-chain alkyl groups are bonded to the graft polymer through graft polymerization, and have at least 6 carbon atoms each. In this embodiment, the orientation controlling force of the spacer surface is great, therefore not causing mono-axial orientation confusion around the spacers. As a result, the device of this embodiment is free from the problem of light leak.

In Embodiment 1 mentioned above, the spacers 30 are fixed to at least one of the electrode substrate 100 or the color filter substrate 101, and are therefore prevented from moving to scratch the alignment layers 24 and 29. In that condition, light leak through the device of Embodiment 1 can be prevented, but it is impossible to prevent light leak therethrough that may be caused by the mono-axial orientation confusion around the spacers 30. On the other hand, in the device of Embodiment 2, it is possible to prevent such light leak to be caused by the mono-axial orientation confusion around the spacers. Accordingly, combining Embodiment 1 and Embodiment 2 ensures an excellent in-plane response-type liquid-crystal display device with no light leak at all and with neither contrast ratio depression nor rough surface appearance, and the device surely enjoys good display characteristics.

### Embodiment 3

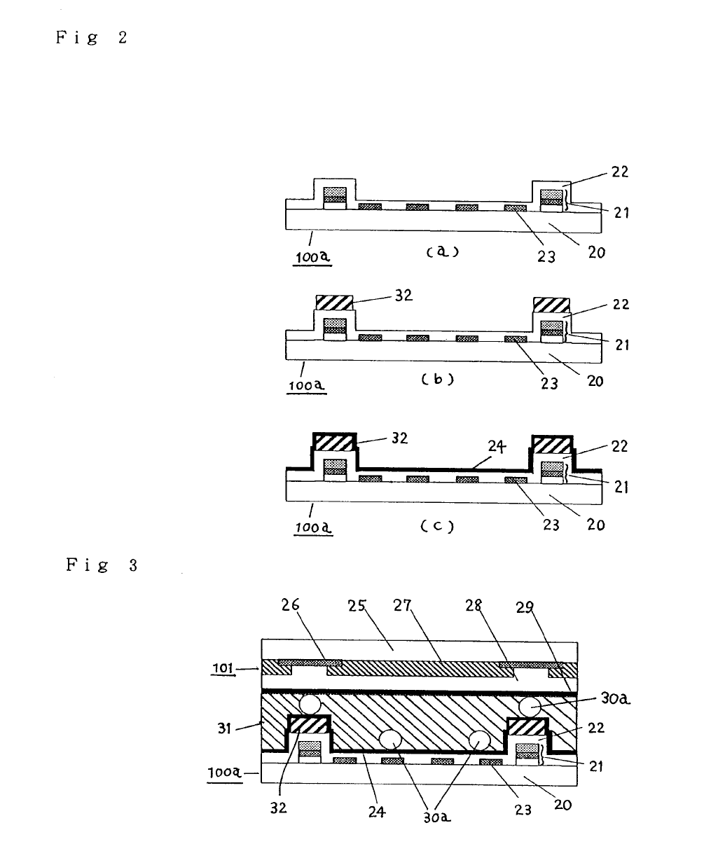

FIG. 2 is a flowchart of Embodiment 3, illustrating a process of fabricating an in-plane response-type liquid crystal display device of the invention, and this shows cross-sectional views of the components of the device being fabricated. FIG. 3 is a cross-sectional view of the in-plane response-type liquid-crystal display device fabricated in Embodiment 3. In these figures, 100a is an electrode substrate formed herein; 32 is a projecting pattern locally formed on the source wire 21; and 30a is a spacer. In these, the same members as hereinabove are designated by the same reference numerals, and their description is omitted herein.

In this embodiment, a projecting pattern 32 is locally formed below the alignment layer 24 on the electrode substrate 100a but above one or both of the gate wire (not shown) and the source wire 21 thereon, and the distance between the electrode substrate 100a and the color filter substrate 101 is defined by the spacers 30a disposed on the projecting pattern 32 while the spacers 30a in the other region are so controlled that they are kept in contact with only one of the electrode substrate 100a and the color filter substrate 101. The size accuracy distribution of ordinary spacers is 0.2 μm or so in terms of the standard deviation, and is 0.6 μm when the value a indicating the process control standard is applied thereto. Accordingly, the height of the projecting pattern 32 may be at least 0.6 μm.

With reference to FIG. 2, the process of fabricating the liquid-crystal display device of this embodiment is described. First, as in FIG. 2A, an electrode substrate 100a is prepared in the same manner as in Embodiment 1 mentioned above. Next, as in FIG. 2B, a projecting pattern 32 having a size of 5 μm (length)×50 μm (width)×0.6 μm (height) is formed on the source line 21 having a line width of 6 μm, through photolithography. Regarding its material, the projecting pattern 32 may be made of pigment or the same material as that for the electrode substrate 100a, e.g., SiN, SiO₂, Al, Cr, etc. However, in view of its influence on the liquid crystal driving behavior, insulating materials such as pigment, SiN, SiO₂ and the like are preferred for the pattern 32. In the illustrated case, SiN is layered to be the pattern 32 having a thickness of 0.6 μm, as its compatibility with the underlying layer is good. Next, as in FIG. 2C, an alignment layer 24 is formed. The components of the device thus prepared are processed and fabricated into a finished liquid-crystal display device in the same manner as in Embodiment 1. FIG. 3 shows the finished device.

In case where the thickness of the liquid crystal layer in the device of this embodiment is the same as that of the liquid crystal layer in the device of Embodiment 1, the diameter of each spacer 30a in the device of this embodiment shall be smaller by the height of the projecting pattern 32, 0.6 μm, than the diameter of the spacer 30 to be in the device of Embodiment 1. Accordingly, the spacers 30a not in the region of the projecting pattern 32, such as those disposed in the pixel region are not kept in contact with both the electrode substrate 100a and the color filter substrate 101. In that condition, the spacers 30a, even though moving in the liquid crystal layer, do not scratch the alignment layers 24 and 29, and do not cause light leak through the device. Therefore, the device is free from the problems of contrast ratio depression and rough surface appearance, and surely enjoys good display characteristics.

### Embodiment 4

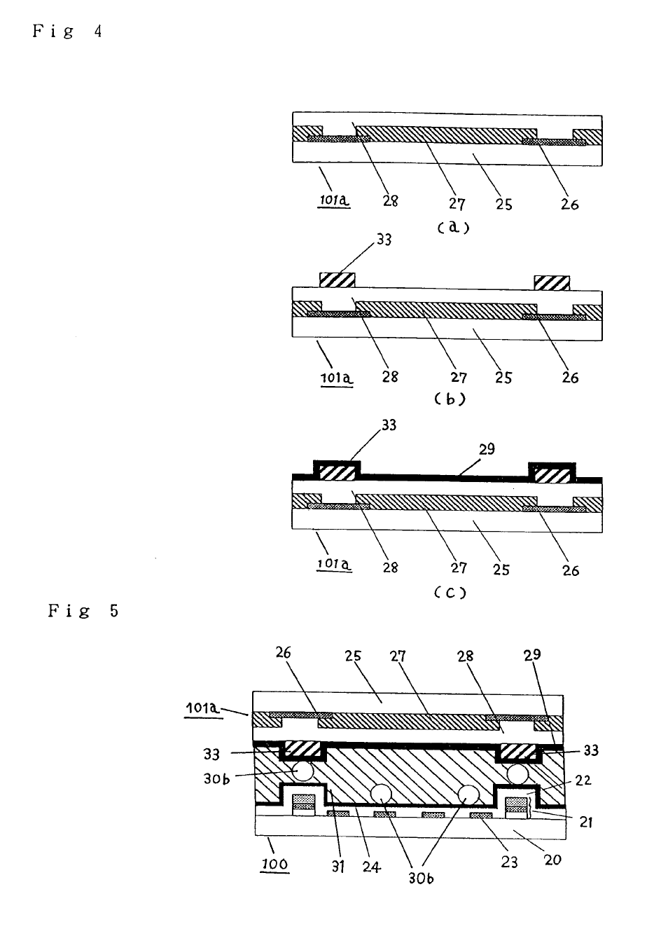

FIG. 4 is a flowchart of Embodiment 4, illustrating a process of fabricating an in-plane response-type liquid-crystal display device of the invention, and this shows cross-sectional views of the components of the device being fabricated. FIG. 5 is a cross-sectional view of the in-plane response-type liquid-crystal display device fabricated in Embodiment 4. In these figures, 101a is a color filter substrate formed herein; 33 is a projecting pattern locally formed on the light-shielding film 26 on the color filter substrate 101a; and 30b is a spacer. In these, the same members as hereinabove are designated by the same reference numerals, and their description is omitted herein.

In this embodiment, a projecting pattern 33 is locally formed below the alignment layer 29 on the color filter substrate 101a but above the light-shielding film 26 thereon, and the distance between the electrode substrate 100 and the color filter substrate 101a is defined by the spacers 30b disposed on the projecting pattern 33 while the spacers 30b in the other region are so controlled that they are not kept in contact with any one of the electrode substrate 100 and the color filter substrate 101a. For the same reason as in Embodiment 3, the height of the projecting pattern 33 may be at least 0.6 μm.

With reference to FIG. 4, the process of fabricating the liquid-crystal display device of this embodiment is described. First, as in FIG. 4A, a light-shielding film 26 of pigment or metal such as chromium or the like, a color filter 27 of pigment or dye, and an overcoat film 28 of an organic or inorganic material are formed on a glass substrate 25 through photography to prepare a color filter substrate 101a. Next, as in FIG. 4B, a projecting pattern 33 having a size of 15 μm (length)×50 μm (width)×0.6 μm (height) is formed on the light-shielding film 26 having a width of 25 μm, through photolithography. Regarding its material, the projecting pattern 33 may be made of pigment or the same material as that for the electrode substrate, e.g., SiN, SiO₂, Al, Cr, etc. However, in view of its influence on the liquid crystal driving behavior, insulating materials such as pigment, SiN, SiO₂ and the like are preferred for the pattern 33. In the illustrated case, an acrylic resin which is the same as that of the overcoat film 28 is layered to be the pattern 33 having a thickness of 0.6 μm, as its compatibility with the underlying layer is good. Next, as in FIG. 4C, an alignment layer 29 is formed. The components of the device thus prepared are processed and fabricated into a finished liquid-crystal display device in the same manner as in Embodiment 1. FIG. 5 shows the finished device.

In case where the thickness of the liquid crystal layer in the device of this embodiment is the same as that of the liquid crystal layer in the device of Embodiment 1, the diameter of each spacer 30b in the device of this embodiment shall be smaller by the height of the projecting pattern 33, 0.6 μm than the diameter of the spacer 30 to be in the device of Embodiment 1. Accordingly, the spacers 30b not in the region of the projecting pattern 33, such as those disposed in the pixel region are not kept in contact with both the electrode substrate 100 and the color filter substrate 101a. In that condition, the spacers 30b, even though moving in the liquid crystal layer, do not scratch the alignment layers 24 and 29, and do not cause light leak through the device. Therefore, the device is free from the problems of contrast ratio depression and rough surface appearance, and surely enjoys good display characteristics.

The structure of Embodiment 3 may be combined with that of Embodiment 4 to attain the same effect as herein. Concretely, projecting patterns are locally formed below the alignment layer on the electrode substrate but above one or both of the gate wire and the source wire, and below the alignment layer on the color filter substrate but above the light-shielding film in such a manner that the two patterns face to each other, and the distance between the electrode substrate and the color filter substrate is defined by the spacers disposed between the facing projecting patterns while the spacers in the other region are so controlled that they are not kept in contact with any one of the electrode substrate and the color filter substrate. In this case, the total height of the projecting patterns formed on the electrode substrate and the color filter substrate may be at least 0.6 μm, and the projecting patterns may be made of an insulating material such as SiN, SiO2 or the like. As the case may be, the two projecting patterns may be so disposed that the position of the projections formed on the electrode substrate differs from that of the projections formed on the color filter substrate.

### Embodiment 5

In the devices of Embodiment 3 and Embodiment 4 mentioned above, a projecting pattern is locally formed on the electrode substrate or on the color filter substrate so that the distance between the electrode substrate and the color filter substrate is defined by the spacers disposed on the projecting pattern while the spacers in the other pixel region are not kept in contact with any one of the electrode substrate and the color filter substrate. In Embodiment 5, the spacers are so controlled that their diameter is smaller in some degree than the distance between the two substrates. In this, therefore, the spacers are kept in contact with only any one of the electrode substrate and the color filter substrate. The diameter, d, of each spacer may satisfies D−d>0.2 μm in which D indicates the distance between the two substrates.

In this embodiment, the spacer diameter is sufficiently smaller than the distance, D, between the two substrates. Therefore, the spacers sandwiched between the two substrates do not scratch the alignment layers, and the device is free from the problem of light leak to be caused by scratched alignment layers. The size accuracy distribution of ordinary pacers is 0.2 μm or so in terms of the standard deviation. Therefore, the necessary difference between the substrate-to-substrate distance and the spacer diameter may be at least 0.2 μm.

### Embodiment 6

In Embodiment 6, the inner pressure in the area of the panel where liquid crystal molecules are disposed is kept lower by at most 0.3 kgf/cm² than the atmospheric pressure in the step of liquid crystal injection and in the step of sealing the two substrate to complete the in-plane response-type liquid-crystal display device of the invention. In the device of this embodiment, the spacers are kept in contact with only any one of the electrode substrate and the color filter substrate, and light leak through the device is prevented.

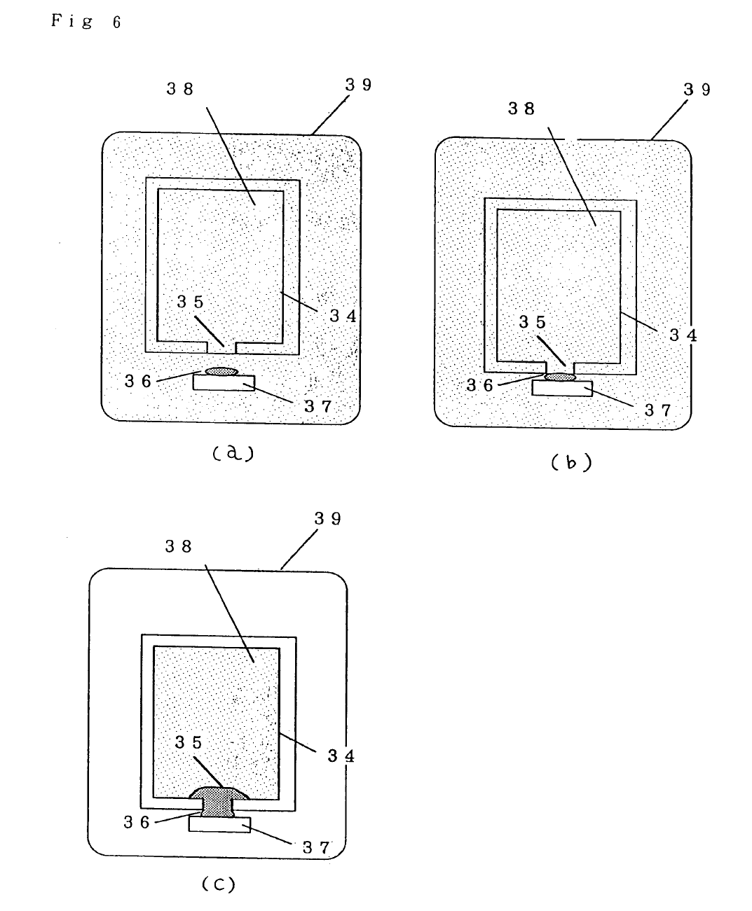

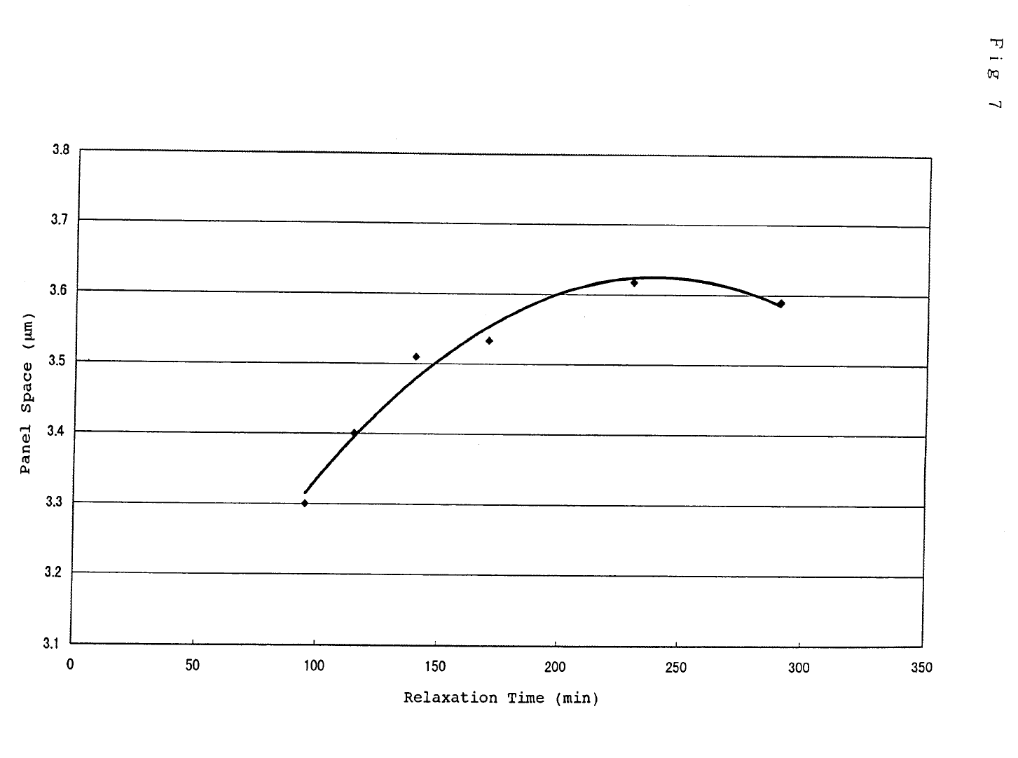

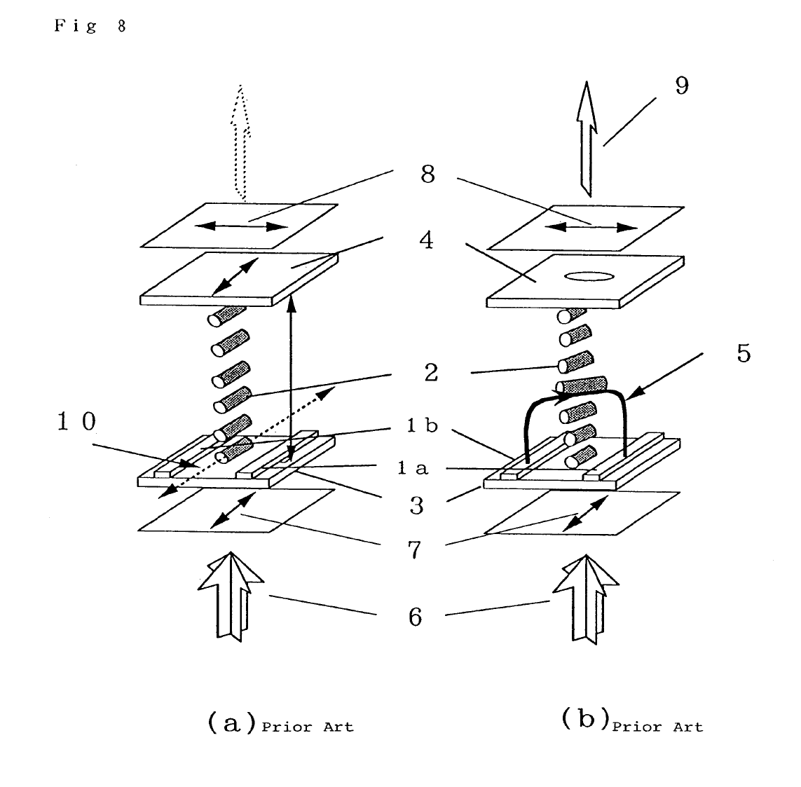

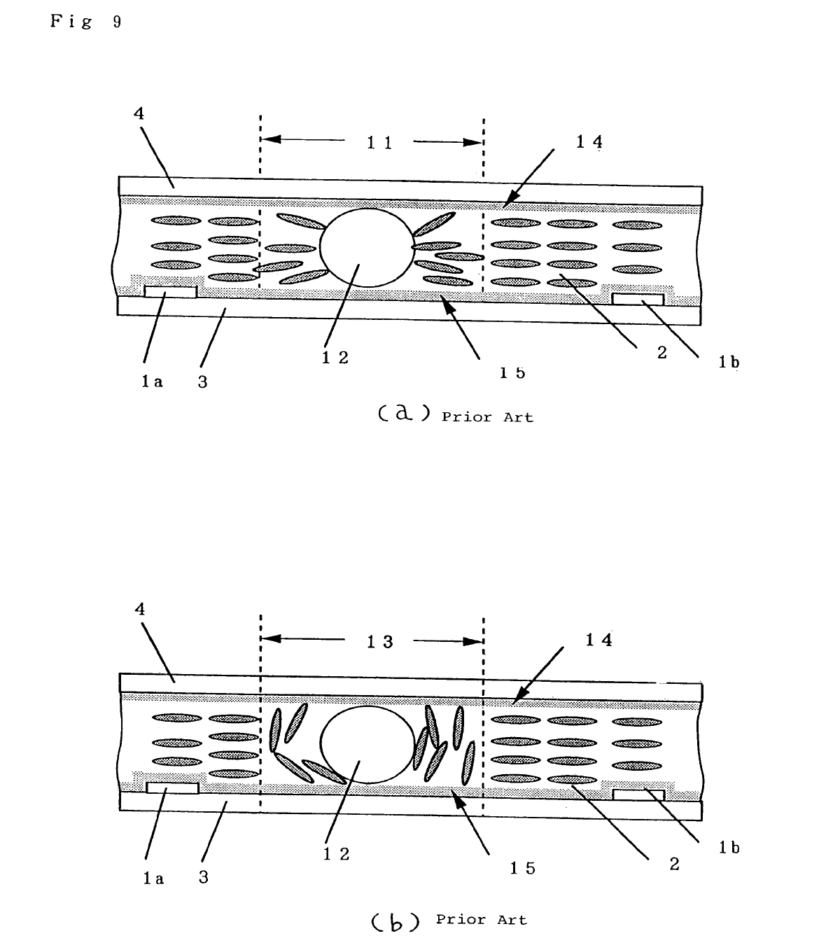

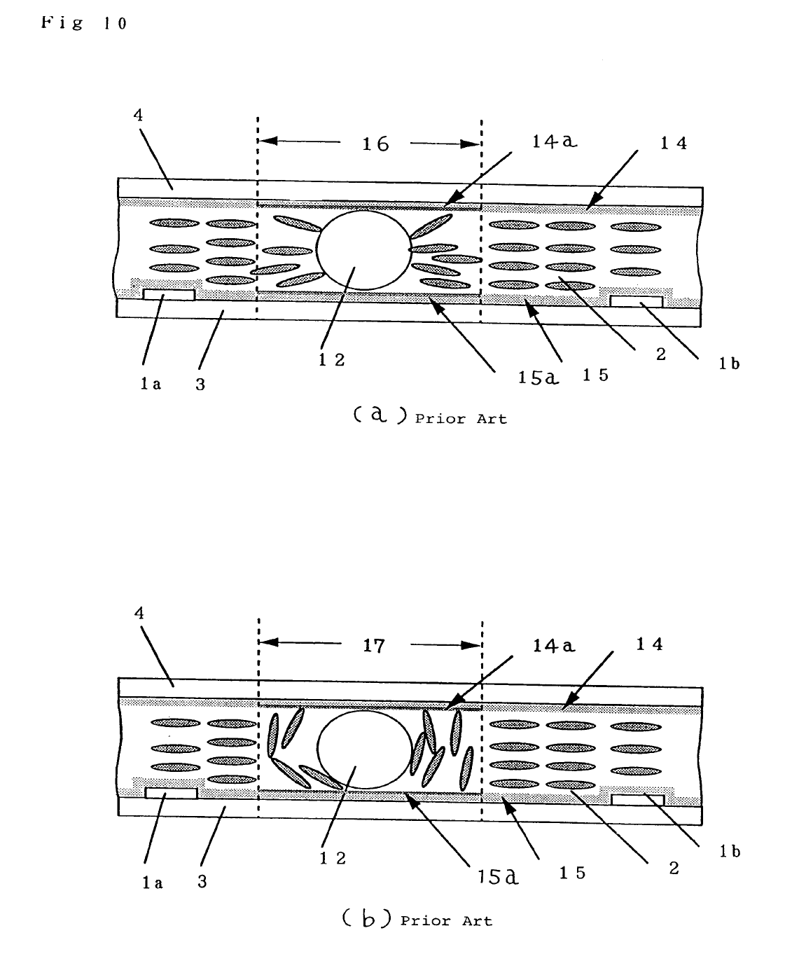

One example of the process of fabricating the liquid-crystal display device of this embodiment is described with reference to FIG. 6. In FIG. 6, 34 is a sealant formed between the two substrates and around the outer peripheries of the substrates in such a manner that it partly reaches the edges of the substrates to form an opening through which liquid crystal is to be injected into the space between the sealed substrates; 36 is liquid crystal; 37 is a container such as a dish filled with liquid crystal 36; 38 is the inside of the panel; and 39 is a liquid crystal-injecting unit.

First, an electrode substrate having plural electrodes such as a gate wire, a source wire, a pixel electrode and others, and an alignment layer all formed thereon is sealed with a color filter substrate having a color filter, a light-shielding film and an alignment layer all formed thereon, via the sealant 34 therebetween to construct a panel.

Next, as in FIG. 6A, the panel is set in a liquid crystal-injecting unit 39 having therein a dish 37 filled with liquid crystal 36, and both the liquid crystal-injecting unit 39 and the panel 38 are evacuated. Though depending on the mechanism and the function of the liquid crystal panel, it is desirable that the two are evacuated to a vacuum degree of around 10⁻² Torr in consideration of the amount of air remaining in the panel 38. The shape and the material of the liquid crystal-injecting unit 39 are not specifically defined so far as its size is enough to house the panel therein and it can be airtightly closed. In the embodiment illustrated in FIG. 6, the panel has one opening 35 for liquid crystal injection, which, however, is not limitative. The panel shall have at least one opening through any one side thereof.

Next, after the inside of the liquid crystal-injecting unit 38 including the panel 39 has been evacuated to have a uniform degree of vacuum, the opening 35 is inserted into the liquid crystal 36, as in FIG. 6B. In that condition, the opening of the panel 38 shall be closed with the liquid crystal 36. Next, while the opening 35 is still kept inserted into the liquid crystal 36 in the dish 37, the liquid crystal-injecting unit is restored to have an atmospheric pressure (760 Torr), as in FIG. 6C. As a result, the liquid crystal 36 is injected into the panel 38 through the opening 35 owing to the inner pressure difference between the panel 38 and the unit 39. After the panel 38 is thus filled with the liquid crystal 36, the opening 35 is sealed with no external pressure applied to the panel 38. In this embodiment illustrated, the panel and the unit are left as they are for at least 120 minutes after the panel has been filled with liquid crystal, and thereafter the opening 35 is sealed. In this condition, the inner pressure of the panel 38 thus filled with liquid crystal is lower by at most 0.3 kgf/cm² than the atmospheric pressure, and the panel 38 will receive only a little pressure. Such a little pressure applied to the panel has no negative influence on the panel, and the panel is free from the problem of light leak through it.

As a rule, in the system of injecting liquid crystal into a panel owing to the difference between the inner pressure of the panel and the atmospheric pressure around the panel, the panel 38 is filled with the liquid crystal 36 when the inner pressure of the panel has become equal to the atmospheric pressure. In the step of FIG. 6C where the liquid crystal 36 is running into the panel 38 through the opening 35, the panel 38 is pressed by the atmospheric pressure. In this condition, therefore, the distance between the two substrates constituting the panel is extremely narrow, and the liquid crystal 36 runs inside the panel owing to the difference between the inner pressure of the panel 38 and the ambient atmospheric pressure and owing to the capillary phenomenon in the narrow distance between the two substrates. After the liquid crystal 36 has reached the sealant 34 existing opposite to the opening 35, the liquid crystal injection will be seemingly finished. In that condition, however, the inner pressure of the panel 38 is negative at the point when the liquid crystal 36 has just reached the sealant 34. The transition time taken from this negative pressure condition to the atmospheric condition inside the panel is referred to as a relaxation time.

FIG. 7 shows a relationship between the relaxation time and the distance (panel space) between facing two substrates that constitute a liquid-crystal display device. The liquid-crystal display device that gave the data shown in FIG. 7 is an S-VGA size, in-plane response-type liquid-crystal device having a diagonal width of 10.4″. Regarding the essential members constituting the device, spherical plastic spacers having a diameter of 3.2 μm (Sekisui Fine Chemical's Micropearl SP-2032) are dispersed inside the panel; an alignment layer (Nippon Synthetic Rubber's Optomer AL1044) having a thickness of 0.06 μm is formed on the facing surfaces of two substrates; glass spacers (Nippon Electric Glass Industry's Microlot PF-45) are added to the sealant (Mitsui Chemical's Structbond XN-21S) which is to seal the two substrates; and a liquid crystal material having a viscosity of 20 cps for ordinary in-plane response-type liquid-crystal display devices is injected into the panel space. The panel has one opening for liquid crystal injection, and the opening has a width of 24 mm. The relationship between the relaxation time and the panel distance under the same condition is referred to. It is understood that the liquid crystal injection is saturated after the relaxation time of about of 200 minutes. Liquid crystal injection into the panel has apparently finished within 210 minutes. Accordingly, it took 410 minutes to completely finish the liquid crystal injection into the panel. The time to be taken for liquid crystal injection increases in proportional to the size of the liquid crystal device being fabricated, and therefore, enlarged output of large-sized devices increases the load to the production lines. Accordingly, in an ordinary process of fabricating conventional TN-type liquid-crystal display devices, the devices being fabricated are transferred into the final sealing step after they have had the necessary panel space and liquid crystal layer unified to a satisfactory degree, so as to ensure the intended output of the finished devices.

However, as compared with such TN-type devices, in-plane response-type liquid-crystal devices require severe process control. Shortening the relaxation time in the step of liquid crystal injection in the process of fabricating the devices inevitably results in reducing the amount of the liquid crystal filled into the panels of the devices. In addition, the spacers in the panels are tightly sandwiched between the facing two substrates, and will have a region of light leak around them. For example, in the case of FIG. 7, the panels had a region of light leak around the spacers when the relaxation time was 100 minutes, but did not have it when the relaxation time was 120 minutes or longer. From this, it is believed that the spacers will be kept in contact to both the facing two substrates after the relaxation time of 100 minutes, but they will be kept in contact to any one of the facing two substrates after the relaxation time of 120 minutes. The inner pressure of the liquid crystal panel is calculated from the panel space after the relaxation time of 120 minutes, and it is lower by 0.28 kgf/cm² than the atmospheric pressure. The relaxation time after which the panels are free from the problem of light leak falls between 100 and 120 minutes. Therefore, in Embodiment 6, it is necessary that the inner pressure of the in-plane response-type liquid-crystal device is controlled to be lower by at most 0.3 kgf/cm² than the atmospheric pressure.

In Embodiments 1 to 6 of the invention described above, the type of the liquid crystal material to be used is not specifically defined, and any ordinary liquid crystal material usable in ordinary TN-type liquid-crystal display devices is employable in the invention. The dielectric anisotropy of the liquid crystal material for use in the invention is not also specifically defined, but preferably falls within the range of 1≦Δ∈≦12. Liquid crystal material having a dielectric anisotropy, Δ∈<1 is poorly responsive to electric fields, and therefore requires high voltage for driving it. On the other hand, liquid crystal material having a dielectric anisotropy, Δ∈>12 is polarized too greatly, and will be therefore readily contaminated with impurities such as ionic impurities and others. The contaminated liquid crystal material is readily degraded. The product of the refractive anisotropy (Δn) of the liquid crystal material for use herein and the panel gap (d), Δn·d, is not specifically defined, but preferably falls between 0.1 μm and 0.4 μm. Even though And is smaller than 0.1 μm or larger than 0.4 μm, the device could act to display images, but the images will be noticeably discolored and the device could not ensure good color reproducibility.

The type of the liquid crystal alignment layer for use in Embodiments 1 to 6 is not specifically defined. For the film, usable are any ordinary soluble polyimides, polyimides from calcined amic acids and others generally used in ordinary liquid-crystal display devices. The pre-tilt angle to be controlled by the film is not specifically defined, but is preferably at most 10 degrees. If larger than 10 degrees, the angle-dependency of visibility of the device will increase, and the device will lose the excellent, angle-independent visibility characteristics intrinsic to in-plane response-type liquid-crystal display devices.

The invention has been described in detail hereinabove with reference to its preferred embodiments. Specifically, the invention provides an in-plane response-type liquid-crystal device in which the surface of each spacer that defines the distance between the facing two substrates is coated with a thermoplastic polymer prepared through graft polymerization of a molecular compound having a vinyl group or a polymerization initiator, with one or more polymerizable monomers at the grafting point of the vinyl group or the polymerization initiator, and each spacer is fixed onto the alignment layer on at least one of the first substrate and the second substrate, via van der Waals bonding or hydrogen bonding between the functional group of the monomers constituting the thermoplastic polymer and the alignment layer. In the device of the invention, therefore, the spacers are prevented from moving to scratch the alignment layers adjacent thereto. Accordingly, the device is free from the problems of light leak therethrough and rough surface appearances, and ensures a satisfactorily high contrast ratio enough to display high-quality images.

In another embodiment of the invention, the spacers used have a number of long-chain alkyl groups in their surfaces. In the device of this embodiment, therefore, the surface of each spacer has large orientation-controlling force enough to prevent the liquid crystal molecules around the spacers from being in mono-axial orientation confusion. Accordingly, the device is free from the problem of light leak therethrough.

In other embodiments of the invention, a projecting pattern is locally formed below the alignment layer on the first substrate but above one or both of the scanning signal line and the image signal line, and/or below the alignment layer on the second substrate but above the light-shielding film, and the distance between the first substrate and the second substrate is defined by the spacers disposed on the projecting pattern while the spacers in the other region are so controlled that they are not kept in contact with any one of the first substrate and the second substrate. In these embodiments, therefore, the spacers are prevented from moving to scratch the alignment layers adjacent thereto. Accordingly, the liquid-crystal display device of these embodiments of the invention is free from the problems of light leak therethrough and rough surface appearances, and ensures a satisfactorily high contrast ratio enough to display high-quality images.

While the invention has been described in detail and with reference to specific embodiments thereof, it will be apparent to one skilled in the art that various changes and modifications can be made therein without departing from the spirit and scope thereof.

1-5. (canceled)

6. A liquid-crystal display device comprising:
a first substrate having thereon plural electrodes that include a scanning signal line, an image signal line, and a pixel electrode;
a second substrate having thereon a color filter and a light-shielding film and spaced from the first substrate via a predetermined distance therebetween;
an alignment layer formed on each of the facing surfaces of the two substrates, the alignment layer of the second substrate being substantially planar;
spacers to define the distance between the two substrates; and
a liquid crystal layer disposed between the two substrates, to which is applied a voltage between the electrodes to thereby form an electric field nearly parallel to the surfaces of the substrates so that the liquid crystal molecules therein undergo in-plane response to the electric field;
wherein a projecting pattern is disposed below the alignment layer on the first substrate but above one or both of the scanning signal line and the image signal line, the distance between the first substrate and the second substrate is defined by the spacers disposed on the projecting pattern, and the spacers in the other region are so controlled that they are kept in contact with only one of the first substrate and the second substrate.

7-10. (canceled)

11. The liquid-crystal display device as claimed in claim 6, wherein the projecting pattern comprises pigment or an insulating material such as SiN or SiO₂.

12-16. (canceled)
